(19) United States
(12) Patent Application Publication
(10) Pub. No.: US 2026/0149875 A1
(43) Pub. Date: May 28, 2026

(54) METHOD, APPARATUS, ELECTRONIC DEVICE, STORAGE MEDIUM, AND PROGRAM PRODUCT FOR CAPTURING IMAGE CONTENT

(71) Applicant: Beijing Zitiao Network Technology Co., Ltd., Beijing (CN)

(72) Inventors: Lishan LI, Beijing (CN); Niwen ZHENG, Beijing (CN)

(21) Appl. No.: 19/301,016

(22) Filed: Aug. 15, 2025

(30) Foreign Application Priority Data
Nov. 28, 2024 (CN) 202411733640.3

(51) Int. Cl. H04N 23/60; H04N 23/63

(52) U.S. Cl. CPC H04N 23/64; H04N 23/632; H04N 23/635

(57) ABSTRACT

Embodiments of the disclosure provide a method, an apparatus, an electronic device, a storage medium, and a program product for capturing image content. The method includes: displaying, in response to a reference image display operation, a target reference image in a first region of a capture interface, the target reference image corresponding to the reference image display operation; displaying capture assistance information in the capture interface, where the capture assistance information is configured to assist capturing based on the target reference image, and at least part of the capture assistance information is determined based on the target reference image; capturing target image content in response to a capture instruction.

### CROSS-REFERENCE

This application claims the benefit of CN Patent Application No. 202411733640.3, filed on Nov. 28, 2024, entitled “METHOD, APPARATUS, ELECTRONIC DEVICE, STORAGE MEDIUM, AND PROGRAM PRODUCT FOR CAPTURING IMAGE CONTENT”, which is hereby incorporated by reference in its entirety.

### FIELD

Embodiments of the present disclosure relate to the field of computer technology, and in particular, to a method, an apparatus, an electronic device, a storage medium, and a program product for capturing image content.

### BACKGROUND

At present, some applications may support displaying a reference image on a capture interface for a user to refer to when capturing. However, in the related art, the effect of capturing image content based on the reference image is poor.

### SUMMARY

Embodiments of the present disclosure provide a method, an apparatus, an electronic device, a storage medium, and a program product for capturing image content, so as to improve the effect of capturing image content based on a reference image.

In a first aspect, an embodiment of the present disclosure provides a method for image capturing, including:
displaying a reference image in a first region of an image capturing interface;
displaying assistance information in the image capturing interface, where the assistance information is configured to assist image capturing based on the reference image, and at least part of the assistance information is determined based on the reference image; and
capturing an image in response to an image capturing instruction.

In a second aspect, an embodiment of the present disclosure further provides an apparatus for image capturing, including:
an image display module configured to display a reference image in a first region of an image capturing interface;
an information display module configured to display assistance information in the image capturing interface, where the assistance information is configured to assist image capturing based on the reference image, and at least part of the assistance information is determined based on the reference image; and
a capture module configured to capture an image in response to an image capturing instruction.

In a third aspect, an embodiment of the present disclosure further provides an electronic device, including:
at least one processors; and
a memory communicatively connected to the at least one processor,
where the memory stores a computer program executable by the at least one processor, and the computer program is executed by the at least one processor to cause the at least one processor to implement the method for image capturing as described according to the embodiments of the present disclosure.

In a fourth aspect, an embodiment of the present disclosure further provides a non-transitory computer-readable storage medium having computer instructions stored thereon, where the computer instructions, when executed by a processor, cause the processor to implement the method for image capturing as described according to the embodiments of the present disclosure.

In a fifth aspect, an embodiment of the present disclosure further provides a computer program product which, when executed by a computer, causes the computer to implement the method for image capturing as described according to the embodiments of the present disclosure.

According to the method, apparatus, the electronic device, the storage medium, and the program product for image capturing provided by the embodiments of the present disclosure, capture assistance information determined based on the currently displayed reference image is supported to be displayed in the capture interface. With the capture assistance information, the user is assisted in capturing based on the currently displayed reference image, which may enrich the manner of capturing image content based on the reference image, reduce the capture difficulty when capturing based on the reference image, and improve the effect of capturing image content based on the reference image.

### BRIEF DESCRIPTION OF THE DRAWINGS

The above and other features, advantages, and aspects of the embodiments of the present disclosure will become more apparent in combination with the drawings and with reference to the following detailed description. Throughout the drawings, the same or similar reference signs refer to the same or similar elements. It should be understood that the drawings are illustrative, and the components and elements are not necessarily drawn to scale.

FIG. 1 is a schematic flowchart of a method for capturing image content provided by an embodiment of the present disclosure;

FIG. 2 is a schematic diagram of displaying a target reference image provided by an embodiment of the present disclosure;

FIG. 3 is a schematic diagram of displaying imaging guidance information provided by an embodiment of the present disclosure;

FIG. 4 is a schematic flowchart of another method for capturing image content provided by an embodiment of the present disclosure;

FIG. 5 is a schematic diagram of displaying capturing mode guidance information provided by an embodiment of the present disclosure;

FIG. 6 is a schematic diagram of displaying capturing object guidance information provided by an embodiment of the present disclosure;

FIG. 7 is a schematic diagram of displaying angle guidance information provided by an embodiment of the present disclosure;

FIG. 8 is a schematic diagram of displaying another imaging guidance information provided by an embodiment of the present disclosure;

FIG. 9 is a structural block diagram of an apparatus for capturing image content provided by an embodiment of the present disclosure; and

FIG. 10 is a schematic structural diagram of an electronic device provided by an embodiment of the present disclosure.

### DETAILED DESCRIPTION

Embodiments of the present disclosure will be described in more detail below with reference to the drawings. Although certain embodiments of the present disclosure are shown in the drawings, it should be understood that the present disclosure may be implemented in various forms, and should not be construed as being limited to the embodiments set forth herein; on the contrary, these embodiments are provided for a more thorough and complete understanding of the present disclosure. It should be understood that the drawings and embodiments of the present disclosure are given only for illustrative purposes, and are not intended to limit the protection scope of the present disclosure.

It should be understood that the various steps described in the method implementations of the present disclosure may be executed in different orders and/or in parallel. In addition, the method implementations may include additional steps and/or omit the execution of the steps shown. The scope of the present disclosure is not limited in this regard.

As used herein, the term “include/comprise” and its variations are open-ended inclusion, that is, “including/comprising but not limited to”. The term “based on” means “at least partially based on”. The term “one embodiment” means “at least one embodiment”; the term “another embodiment” means “at least one other embodiment”; the term “some embodiments” means “at least some embodiments”. Relevant definitions of other terms will be given in the following description.

It should be noted that concepts such as “first” and “second” mentioned in the present disclosure are only used to distinguish different apparatuses, modules or units, and are not used to limit the order of functions performed by these apparatuses, modules or units, or interdependence therebetween.

It should be noted that the modifiers of “one” and “a plurality of” mentioned in the present disclosure are illustrative and not restrictive, and those skilled in the art should understand that unless otherwise explicitly indicated in the context, they should be understood as “one or more”.

The names of messages or information exchanged between a plurality of apparatuses in the implementations of the present disclosure are only for illustrative purposes, and are not intended to limit the scope of these messages or information.

It may be understood that the data involved in the technical solution (including but not limited to the data itself, acquisition or use of the data) should comply with requirements of corresponding laws, regulations and related provisions.

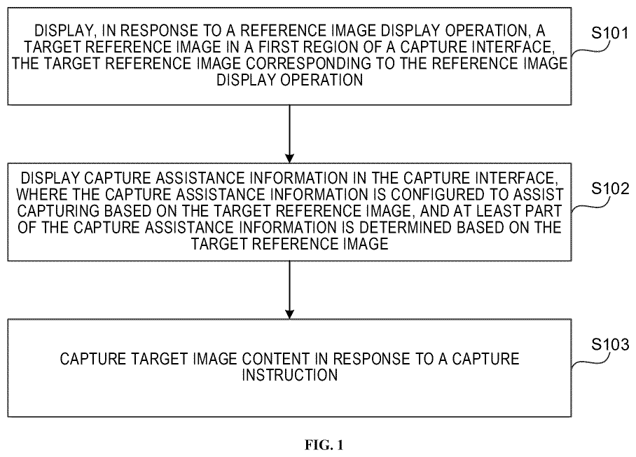

FIG. 1 is a schematic flowchart of a method for capturing image content provided by an embodiment of the present disclosure. The method may be executed by an apparatus for capturing image content, where the apparatus may be implemented by software and/or hardware, may be configured in an electronic device, and typically may be configured in a computer, a mobile phone or a tablet computer. The method for capturing image content provided by the embodiments of the present disclosure is applicable to a scenario of capturing image content based on a reference image, such as a scenario of guiding to capture image content based on the reference image by capture assistance information. As shown in FIG. 1, the method for capturing image content provided by the embodiment may include:
S101, displaying, in response to a reference image display operation, a target reference image in a first region of a capture interface, the target reference image corresponding to the reference image display operation.

The reference image display operation may be a trigger for indicating display of a reference image in the capture interface, which may be also referred to as an image capturing interface. The implementation of the reference image display operation is not limited. By way of example, the reference image display operation may be triggered via a media content display interface and/or the capture interface. For example, the reference image display operation may be performed based on an operation of triggering a certain control within the media content display interface and/or the capture interface, or an operation of performing a preset gesture within the media content display interface and/or the capture interface, and so on. The target reference image may be understood as a reference image to be displayed as indicated by the reference image display operation. The first region is a region in which the target reference image is displayed in the capture interface, such as a region for displaying the target reference image in the capture interface. The first region may be set in advance or adjusted based on the user's adjustment operation for the display region of the target reference image.

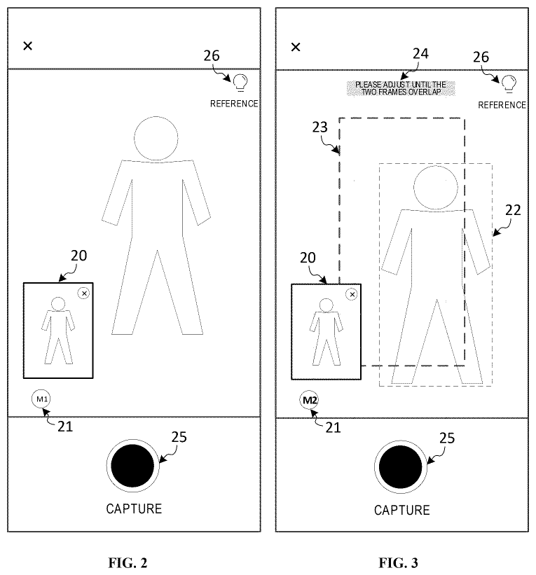

By way of example, in the case that the reference image display operation is received, the target reference image 20 corresponding to the reference image display operation may be acquired in response to the reference image display operation, and the target reference image 20 may be displayed in the first region of the capture interface, as shown in FIG. 2.
S102, displaying capture assistance information in the capture interface, where the capture assistance information is configured to assist capturing based on the target reference image, and at least part of the capture assistance information is determined based on the target reference image.

The capture assistance information, which is also referred to as assistance information, may be information for assisting the current user to capture based on the target reference image displayed in the capture interface. For example, the capture assistance information may be configured to assist the current user to adjust a capturing parameter based on the target reference image displayed in the capture interface, to capture image content having similar picture content and/or similar composition of picture as the target reference image. The manner for determining the capture assistance information is not limited, and at least part of the capture assistance information may be determined based on the target reference image displayed in the capture interface. For example, the capture assistance information corresponding to a parameter item that does not match between capturing parameter information of the capture interface and target parameter information of the target reference image may be displayed, to prompt the current user to adjust the parameter item of the capture interface. In some examples, the capture assistance information corresponding to some parameter items may alternatively be determined based on preset parameter information. When capturing parameter information of a parameter item of the capture interface does not match the preset parameter information, the capture assistance information corresponding to the parameter item is displayed, to prompt the current user to adjust the parameter item of the capture interface, etc.

By way of example, as shown in FIG. 3, in the case that the target reference image 20 is displayed in the capture interface, the capture assistance information may be displayed in the capture interface. For example, the capture assistance information determined based on the target reference image 20 may be displayed in the capture interface, such as capturing guidance information such as a current parameter value 21 of a first capturing parameter of the capture interface and/or a first guidance element 22, a second guidance element 23, and a text guidance element 24 corresponding to a second capturing parameter of the capture interface as shown in FIG. 3; and/or, the capture assistance information determined by other manners may be displayed in the capture interface, such as the reference lines as shown in FIG. 3.

In this embodiment, a display timing of the capture assistance information is not limited. In some examples, in the case that a capture assistance function of a current application is in an on state, the capture assistance information may be displayed in the capture interface in response to the display of the target reference image, and the capture assistance information currently to be displayed is displayed in the capture interface; and in the case that the capture assistance function of the current application is in an off state, when the target reference image is initially displayed, the capture assistance information may not be displayed in the capture interface, and the capture assistance information currently to be displayed may be displayed in the capture interface in response to the capture assistance function of the current application switching from the off state to the on state. When the capture assistance information is displayed in the capture interface, different pieces of the capture assistance information may be displayed simultaneously or non-simultaneously. For the capture assistance information displayed non-simultaneously, a display sequence thereof may be set in advance, which is not limited in this embodiment. The capture assistance function may be understood as a function of assisting the user to capture based on the displayed reference image by displaying the capture assistance information when the reference image is displayed, which may be enabled or disabled by the current user as needed. In the following, the capture assistance function being enabled is taken as an example for description.
S103, capturing target image content in response to a capture instruction.

The capture instruction (e.g., an image capturing instruction) may be an instruction for instructing capturing. The target capturing content may be understood as image content captured in response to the capture instruction, which may be picture content or video content.

Specifically, when the capture instruction is received, a camera may be controlled to capture in response to the capture instruction, and as a result, to obtain the target image content (e.g., an image).

In this embodiment, the condition for acquiring the capture instruction is not limited. For example, the capture instruction may be automatically acquired when a set condition is satisfied, for example, when capturing parameter information of the capture interface matches capturing parameter information of the displayed capture assistance information and/or the target reference image, and a current user does not need to perform a capture operation (e.g., an image capturing operation). Alternatively, to further enrich manners of capturing the image content, the capture instruction may be acquired when the capture operation performed by the current user is received, and so on.

In this case, optionally, the method for capturing image content further includes at least one of the following: acquiring feedback information and/or the capture instruction based on a determination that capturing parameter information of the capture interface matches the capture assistance information; acquiring feedback information and/or acquiring the capture instruction in accordance with a determination that capturing parameter information of the capture interface matches the capture assistance information; and acquiring the capture instruction based on a capture operation.

The capturing parameter information of the capture interface may be understood as parameter information of a capturing parameter of the capture interface, such as a current parameter value of the capturing parameter of the capture interface. The capturing parameter information may include, for example, a capturing mode, imaging information, and/or a capturing angle. The feedback information may be information configured for feedback when the capturing parameter information of the capture interface matches the capture assistance information. For example, the feedback information may be configured for prompting that corresponding capturing parameter information of the capture interface successfully matches the capture assistance information displayed in the capture interface. The target parameter information may be understood as parameter information of the target reference image, such as a capturing mode, imaging information, and/or a capturing angle of the target reference image. The capture operation may be a trigger for instructing to capture. The implementation of the capture operation is not limited. By way of example, the capture operation may include an operation of triggering a capture control displayed in the capture interface or an operation of performing a preset capture gesture.

In some examples, the feedback information may be displayed and/or the target image content may be captured in response to the capturing parameter information of the capture interface matching the capture assistance information. By way of example, in the case that it is determined, through detection, that the capturing parameter information of the capture interface matches the capture assistance information, the feedback information and/or the capture instruction may be acquired. For example, in the case that it is determined, through detection, that the capturing parameter information of the capture interface matches the capture assistance information currently displayed in the capture interface, the feedback information may be displayed, and the feedback information may be configured for prompting that the capturing parameter information of the capture interface successfully matches the capture assistance information currently displayed in the capture interface; and/or, the capture instruction is acquired, or it is determined whether there is next piece of capture assistance information to be displayed. If yes, the next piece of capture assistance information may be displayed in the capture interface; if no, the capture instruction may be acquired. After the capture instruction is acquired, the target image content may be captured in response to the acquired capture instruction.

Considering that the capture assistance information may be configured for guiding the current user to capture based on the target reference image, in some examples, whether the capturing parameter information of the capture interface matches the capture assistance information may be determined based on whether the capturing parameter information of the capture interface matches the target parameter information of the target reference image, and in the case that it is determined that the capturing parameter information of the capture interface matches the capture assistance information, the feedback information may be displayed and/or the target image content may be captured. By way of example, the feedback information may be acquired and/or the target image content may be captured in response to the capturing parameter information of the capture interface matching the target parameter information of the target reference image currently displayed in the capture interface. For example, in the case that it is determined, through detection, that the capturing parameter information of the capture interface matches the target parameter information of the target reference image, it is determined that the capturing parameter information of the capture interface matches the capture assistance information, the feedback information is acquired and/or the capture instruction is acquired, and the target image content is captured in response to the capture instruction. In this case, optionally, the acquiring feedback information and/or the capture instruction based on a determination that capturing parameter information of the capture interface matches the capture assistance information includes: acquiring the feedback information and/or the capture instruction based on a determination that the capturing parameter information of the capture interface matches the target parameter information of the target reference image.

In some examples, the target image content may be captured in response to a received capture operation. For example, when the capture operation for the capture interface is received, for example, when it is detected that the current user triggers the capture control 25 (as shown in FIGS. 2 and 3) displayed in the capture interface, the capture instruction is acquired, and in response to the capture instruction, the target image content is captured.

In the method for capturing image content provided by the this embodiment, the target reference image corresponding to the reference image display operation is displayed in the first region of the capture interface in response to the reference image display operation; the capture assistance information is displayed in the capture interface, the capture assistance information is configured to assist capturing based on the currently displayed target reference image, and at least part of the capture assistance information is determined based on the currently displayed target reference image; and the target image content is captured in response to the capture instruction. In the embodiments, with the above technical solution, the capture assistance information determined based on the currently displayed reference image is supported to be displayed in the capture interface, and the user is assisted to capture based on the currently displayed reference image through the capture assistance information, which may enrich the manners of capturing image content based on the reference image, reduce the capture difficulty when capturing based on the reference image, and improve the effect of capturing image content based on the reference image.

In some embodiments, the target reference image may be acquired based on media content posted in a current application. For example, image content in the media content posted in the current application may be acquired as the target reference image, and/or the target reference image may be generated based on the media content posted in the current application, and so on. For the case of acquiring the target reference image based on the media content posted in the current application, for example, the capture assistance information displayed in the capture interface when the currently used reference image is the target reference image may be determined based on target media content corresponding to the target reference image and/or association input by a user who posts the target media content when the user posts the target media content, so as to further enrich the determination manner of the capture assistance information. In this case, optionally, the target reference image is associated with target media content posted by a user of a current application, and the capture assistance information is determined based on the target media content posted by the user or associated information input by the user. The target media content may be understood as media content associated with the target reference image. The associated information may be understood as information associated with the target reference image and input by the user who posts the target media content, such as editing information for image content associated with the target reference image by the user who posts the target media content.

Optionally, the capture assistance information is determined based on the target media content posted by the user or the associated information input by the user, includes: the capture assistance information is determined through image detection based on the target media content posted by the user; and/or the capture assistance information is determined based on image information of the target media content edited by the user.

For example, in a case where the poster authorizes the posted content as a reference image for other users to capture, after the target media content is posted, image detection may be performed on the target media content, to determine image information of an image picture in the target media content, and the capture assistance information when the currently used reference image is the target reference image corresponding to the target media content is determined based on the image information; and/or, the image information, edited by the user, of the target media content is acquired, and the capture assistance information when the currently used reference image is the target reference image corresponding to the target media content is determined based on the image information. The image information may include but is not limited to capturing parameter information of the image content, such as a zoom ratio, an aperture parameter, a capturing mode, imaging information, and/or a capturing angle of the image content, which is not limited in the this embodiment.

In some examples, an image information detection model for detecting and determining the image information of the image content may be pre-trained. By way of example, in the case that original image information (such as image information when the image content is captured or image information edited by the user) of the image content corresponding to the target reference image is associated in the current application, when the image content and the original image information thereof are input into the image information detection model, target image information, output by the image information detection model, of the image content may be acquired; and in the case that the original image information of the image content corresponding to the target reference image is not stored in the current application, when the image content is input into the image information detection model, the target image information, output by the image information detection model, of the image content may be acquired. After the target image information of the image content is acquired, the capture assistance information when the currently used reference image is the target reference image may be determined based on the target image information.

In this embodiment, a display position in the capture interface of the capture assistance information determined based on the target media content posted by the user or the associated information input by the user may be set as needed. Optionally, displaying the capture assistance information in the capture interface includes: acquiring the capture assistance information determined based on the target media content posted by the user or the associated information input by the user, and displaying the capture assistance information in an associated position of the capture interface, where the associated position is a preset position and/or is associated with a type of the capture assistance information.

The associated position may be understood as the display position in the capture interface of the capture assistance information determined based on the target media content posted by the user or the associated information input by the user, such as the display position in the second region of the capture interface. The associated position may be a preset position, such as a preset display position in the capture interface of certain capture assistance information; or the associated position may be associated with the type of the capture assistance information, such as different types of capture assistance information may have different display positions in the capture interface, etc.

Specifically, the capture assistance information when the currently used target reference image is the target reference image may be acquired based on the target media content posted by the user in the current application and/or the associated information input by the user, and the capture assistance information may be displayed in the preset position and/or a position associated with the type of the capture assistance information. For example, the capture assistance information corresponding to some capturing parameters (such as the first capturing parameter) may be displayed in the preset position of the capture interface; and/or, the capture assistance information corresponding to another part of capturing parameters (such as the second capturing parameter) may be displayed in the associated position associated with the type of the capture assistance information in the capture interface. By way of example, text-based capture assistance information (such as text guidance information) may be displayed in a set position of the capture interface, and non-text-based capture assistance information (such as a guidance element, and so on) may be displayed in a position associated with a capturing object in the target reference image and/or in a position associated with a capturing object in the preview image, etc., so as to further enrich the manner of displaying the capture assistance information, and improve the assistance effect of the capture assistance information.

In some implementations, the current user may be supported to determine the reference image based on image content in the media content when viewing the media content posted in the current application, to capture with reference to the determined reference image. In this case, optionally, displaying the target reference image in the first region of the capture interface in response to the reference image display operation includes: displaying a media content display interface; displaying the target media content in the media content display interface; and displaying the capture interface based on a trigger for the media content display interface, and displaying the target reference image and/or the associated information of the target media content in the first region of the capture interface, where the target reference image is determined based on the target media content.

Specifically, the media content display interface may be displayed, and the target media content may be displayed in the media content display interface. When the trigger for the media content display interface is received, the capture interface is displayed, and the target reference image determined based on the target media content and/or the associated information of the target media content are displayed in the capture interface, as shown in FIG. 2 (the associated information of the target media content is not shown in the figure).

It may be understood that the media content display interface may be a recommendation interface for displaying media content or a detail page for displaying media content in the current application. The media content may be displayed in a media content stream, and the media content stream may include a plurality of pieces of media content posted by a plurality of users of the current application platform. The user may switch between the plurality of pieces of media content in the media content stream based on a content switching operation, such as an up-down sliding operation. The user may also interact with other users based on the media content, such as giving a like, commenting or sharing for interactive media content.

In some examples, the target media content may be displayed in the media content display interface. When a first trigger applied on the media content display interface is received, for example, when it is detected that the current user triggers a reference capture control corresponding to the target media content, image content (such as picture content or a video frame) in the target media content currently displayed in the media content display interface may be used as the target reference image, the capture interface is displayed, and the associated information of the target reference image and/or the target media content is displayed in the first region of the capture interface. Additionally or alternatively, when a second trigger applied on the media content display interface is received, for example, when it is detected that the current user triggers a reference image favoriting control corresponding to the target media content, the image content in the target media content currently displayed in the media content display interface may be used as the target reference image, the capture interface is displayed, the associated information of the target reference image and/or the target media content is displayed in the first region of the capture interface, and the target reference image is added to a favorite reference image set of the current user. The favorite reference image set may be understood as a set of reference images favorited by the current user.

In some implementations, the current user may be supported to trigger, based on the capture interface, the display of the reference image associated with the media content, to capture with reference to the displayed reference image. In this case, optionally, displaying the target reference image in the first region of the capture interface in response to the reference image display operation includes: displaying the capture interface; and displaying the target reference image and/or associated information of the target media content in the first region of the capture interface in response to a trigger for the capture interface, where the target reference image is determined based on the target media content.

Specifically, the capture interface may be displayed. When a reference image panel display operation acting on the capture interface is received, for example, when it is detected that the current user triggers a reference image panel display control 26 (as shown in FIGS. 2 and 3) displayed in the capture interface, a reference image panel is displayed in the capture interface, and at least one piece of candidate reference image information may be displayed in the reference image panel. A candidate reference image corresponding to at least part of the candidate reference image information in the reference image panel is determined based on the media content posted in the current application. When it is detected that the current user performs the selection operation on the candidate reference image information of a certain candidate reference image determined based on a certain piece of media content in the reference image panel, the candidate reference image may be used as the target reference image 20, the media content corresponding to the reference image may be used as the target media content, and the associated information of the target reference image 20 and/or the target media content is displayed in the first region of the capture interface.

In this embodiment, with the technical solution described above, the determination manner of the reference image and the determination manner of the capture assistance information may be further enriched, so as to satisfy the requirements of the user to capture with reference to different image content.

In some embodiments, the capture assistance information associated with the target reference image may be generated based on the parameter information associated with the target reference image, so as to assist the current user to adjust the capturing parameter information of the capture interface to match the parameter information of the target reference image through the capture assistance information, thereby reducing the difficulty of adjusting reference information when capturing based on the target reference image. In this case, optionally, the at least part of the capture assistance information being associated with the target reference image includes: the at least part of the capture assistance information is generated based on parameter information associated with the target reference image, and the parameter information is determined based on image information associated with the target reference image and/or obtained based on image detection.

The parameter information associated with the target reference image may be determined based on the image information associated with the target reference image. For example, the parameter information of the target reference image may be determined based on the image information of the target reference image, and/or the parameter information associated with the target reference image may be determined based on image information of the target media content corresponding to the target reference image and/or image information of image content corresponding to a target parameter image in the target media content. Additionally or alternatively, the image information associated with the target reference image may be obtained based on image detection. For example, image detection may be performed on the target reference image, the target media content corresponding to the target reference image, or the image content corresponding to the target reference image in the target media content, and the detected parameter information is used as the parameter information associated with the target reference image.

The information type of the parameter information associated with the target reference image is not limited. Optionally, the parameter information includes at least one of a target parameter value, a target capturing mode, target imaging information, and a target capturing angle. The target parameter value may be understood as a value of a capturing parameter associated with the target reference image, such as a value of a zoom ratio (e.g., zoom factor) and/or an aperture parameter associated with the target reference image. The target capturing mode may be understood as a capturing mode for the target reference image, and the capturing mode may include, for example, a portrait capturing mode and/or a landscape capturing mode. The target imaging information may be understood as imaging information of the target reference image, such as imaging size information and/or imaging position information of a second capturing object in the target reference image. The target capturing angle information may be understood as capturing angle information associated with the target reference image, such as a rotation angle and/or a pitch angle when the target reference image is captured.

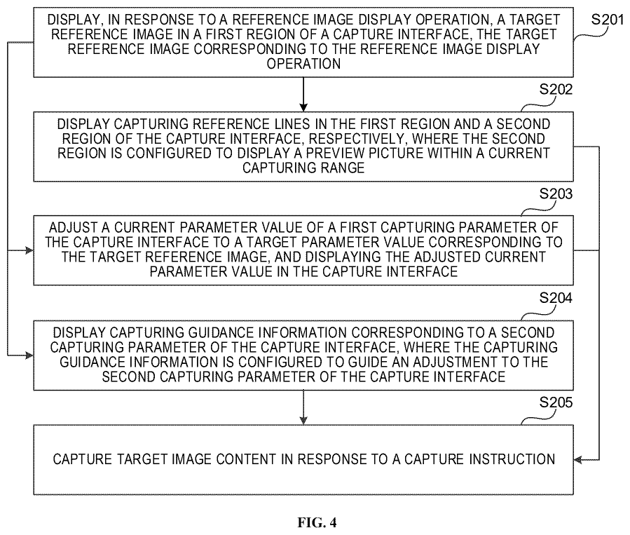

FIG. 4 is a schematic flowchart of another method for capturing image content provided by an embodiment of the present disclosure. The solution in this embodiment may be combined with one or more optional solutions in the embodiments described above. Optionally, displaying the capture assistance information in the capture interface includes at least one of the following: displaying reference lines in the first region and a second region of the capture interface, respectively, where the second region is configured to display a preview picture within a current capturing range; adjusting a current parameter value of a first capturing parameter of the capture interface to a target parameter value corresponding to the target reference image, and displaying the adjusted current parameter value in the capture interface; and displaying capturing guidance information corresponding to a second capturing parameter of the capture interface, where the capturing guidance information is configured to guide an adjustment to the second capturing parameter of the capture interface.

Accordingly, as shown in FIG. 4, the method for capturing image content provided by the embodiment may include:
S201, displaying, in response to a reference image display operation, a target reference image in a first region of a capture interface, and executing at least one of S202-S204, where the target reference image corresponds to the reference image display operation.

In S202, displaying reference lines in the first region and a second region of the capture interface, respectively, where the second region is configured to display a preview image within a current capturing range.

The second region may be a region in the capture interface for displaying a preset image within a current capturing range of a camera, such as a preset image display region of the capture interface. The reference lines may be understood as reference lines for assisting the user to capture. The display form of the reference lines is not limited, for example, the reference lines may be displayed in the form of diagonal lines and/or grid lines. Optionally, the reference lines include grid reference lines. By way of example, the grid reference lines displayed in the first region may be configured for dividing the first region into a nine-square grid form, and the reference lines displayed in the second region may be configured for dividing the second region into a nine-square grid form, etc., so as to assist the user to locate the capturing content.

Specifically, when the target reference image is displayed in the first region of the capture interface, the reference lines may be displayed in the first region and the second region of the capture interface respectively. That is, the reference lines are displayed in the reference image region and the preview image region of the capture interface respectively, as shown in FIG. 3 (in the figure, the reference lines is shown as the grid reference lines as an example), for the current user to view, with reference to the reference lines, picture content at positions in the target reference image and the preview image that correspond to each other, so as to provide convenience for the user to adjust a picture within the current capturing range based on the target reference image.

In S203, adjusting a current parameter value of a first capturing parameter of the capture interface to a target parameter value corresponding to the target reference image, and displaying the adjusted current parameter value in the capture interface.

The first capturing parameter may be understood as a capturing parameter of the capture interface that is automatically adjusted based on the target reference image after the target reference image is displayed. The first capturing parameter may be set as needed. Optionally, the first capturing parameter includes a zoom ratio; and/or, the first capturing parameter includes an aperture parameter. The zoom ratio may be understood as a ratio by which an image is enlarged during capturing. The aperture parameter may be understood as a parameter of an aperture, which may be configured for controlling an amount of incoming light during capturing.

By way of example, when the target reference image 20 is displayed in the first region of the capture interface, a target parameter value corresponding to the first capturing parameter of the target reference image 20 may be acquired, and a current parameter value 21 of the first capturing parameter of the capture interface is adjusted to the target parameter value, and the adjusted current parameter value 21 is displayed in the capture interface, that is, the target parameter value corresponding to the target reference image is displayed in the capture interface, as shown in FIG. 3 (in the figure, the current parameter value 21 being a current zoom ratio value is taken as an example).

For example, if the first capturing parameter is the zoom ratio, in response to the display of the target reference image, the target zoom ratio value of the zoom ratio corresponding to the target reference image is acquired, the current zoom ratio value of the zoom ratio in the capture interface is adjusted to the target zoom ratio value, and the adjusted current zoom ratio value is displayed in the capture interface.

In some implementations, for example, if the first capturing parameter is the zoom ratio, the current zoom ratio value of the capture interface may be adjusted to the target zoom ratio value of the target parameter image by optical zooming and/or digital zooming. In this case, optionally, the adjusting the current parameter value of the first capturing parameter of the capture interface to the target parameter value corresponding to the target reference image includes: performing zooming processing on an original preview image within the current capturing range based on the target parameter value of the target reference image, and displaying, in the second region, a target preview image obtained through the zooming processing, where the zooming processing includes optical zooming processing and/or digital zooming processing.

The original preview image may be understood as a preview image before zooming processing is performed. The target preview image may be understood as a preview image obtained after zooming processing is performed. The optical zooming processing may be understood as a zooming processing manner in which a focal length is changed by adjusting a currently used camera and/or lens. Digital zooming may be understood as a zooming processing manner in which an acquired preview image is cropped and enlarged by an image processing manner.

By way of example, based on the target parameter value of the target reference image, the optical zooming processing and/or the digital zooming processing may be performed on the original preview image within the current capturing range, so as to obtain the target preview image, and the target preview image may be displayed in the second region.

In the above implementations, whether to perform the optical zooming processing or the digital zooming processing on the original preview image, or to adopt a combination of the above two manners of zooming processing may be flexibly set as needed, which is not limited in the embodiments. In some examples, the priority of the optical zooming processing may be higher than the priority of the digital zooming processing. In other words, in a case where the optical zooming processing may be adopted, the optical zooming processing may be preferentially adopted to perform the zooming processing on the preview image on which the zooming processing is to be performed; and in a case where the optical zooming processing cannot be adopted, the digital zooming processing may be adopted to perform the zooming processing on the preview image on which the zooming processing is to be performed. For example, assuming that there are 0.5×, 1×, and 2× cameras in the electronic device corresponding to the current application, and a target zoom ratio associated with the target reference image is 2.5×, the optical zooming processing may be first performed to switch the currently used camera to the 2× camera, and then the digital zooming processing is performed based on the preview image acquired by the 2× lens, and the preview image acquired by the 2× camera is cropped and enlarged to achieve the effect of 2.5× zooming.

In S204, displaying capturing guidance information corresponding to a second capturing parameter of the capture interface, where the capturing guidance information is configured to guide an adjustment to the second capturing parameter of the capture interface.

The second capturing parameter may be understood as a capturing parameter that guides the user to adjust by displaying the capturing guidance information. The second capturing parameter may be set as needed. Optionally, the second capturing parameter includes at least one of a current capturing mode, current imaging information of a first capturing object, and a current capturing angle, where the current capturing mode includes a portrait capturing mode and/or a landscape capturing mode, the first capturing object is an object to be captured, and the imaging information includes an imaging size and/or an imaging position.

The current capturing mode may be understood as a capturing mode currently used in the capture interface, which may include the portrait capturing mode and/or the landscape capturing mode. The first capturing object may be understood as a capturing object currently captured in the capture interface, such as a current capture subject in the capture interface. The imaging information of the first capturing object may be understood as imaging information of the first capturing object in the capture interface, such as an imaging size and/or an imaging position of the first capturing object. The imaging size may be understood as a size of an image of the first capturing object in the preview image displayed in the capture interface. The imaging position may be understood as a position of the image of the first capturing object in the preview image displayed in the capture interface. The current capturing angle may be understood as a current capturing angle of the capture interface, such as a current rotation angle and/or a current pitch angle of the capture interface.

The capturing guidance information may be understood as information configured for guiding the adjustment to the second capturing parameter of the capture interface.

Specifically, in the presence of the target reference image 20 in the capture interface, the capturing guidance information corresponding to the second capturing parameter of the capture interface may be displayed. For example, if there is a second capturing parameter whose current parameter value does not match the target parameter information and/or the preset parameter information of the target reference image 20, the capturing guidance information corresponding to the second capturing parameter may be generated based on the current parameter value of the second capturing parameter and the target parameter value and/or the preset parameter value to be adjusted to, and the capturing guidance information may be displayed in the capture interface, as shown in the first guidance element 22, the second guidance element 23, the text guidance information 24, and the like in FIG. 3, so as to guide the user to adjust the current parameter value of the second capturing parameter of the capture interface by the capturing guidance information.

In this embodiment, the second capturing parameter guided by the capturing guidance information may be enabled to be preset. For example, which capturing parameters may be used as the second capturing parameter to be guided by the capturing guidance information may be set in advance. Alternatively, the second capturing parameter guided by the capturing guidance information may be enabled to be determined based on an object type and/or an object number of a second capturing object in the target reference image. For example, in the case that the object types and/or the object numbers of the second capturing object in the target reference image are different, different second capturing parameters may be enabled to be guided by the capturing guidance information. By way of example, in the case that the target reference image is a single-person image, the current capturing mode of the capture interface, the current imaging information of the first capturing object, and the like may be enabled to be guided by the capturing guidance information; and in the case that the target reference image is a multi person image or a scenery image, the current capturing mode of the capture interface, the current capturing angle of the capture interface, and the like may be enabled to be guided by the capturing guidance information, etc., so as to further enrich the capturing guidance manners. In this case, optionally, the second capturing parameter guided by the capturing guidance information is enabled to be set in advance, or the second capturing parameter to be guided by the capturing guidance information is enabled to be determined based on an object type and/or an object number of the second capturing object in the target reference image. The second capturing object may be understood as a capturing object in the target reference image, such as a capture subject of the target reference image.

In S205, capturing target image content in response to a capture instruction.

In this embodiment, in the case that the capture instruction is acquired, the target image content may be captured in response to the capture instruction.

According to the method for capturing image content provided by the embodiments, the user may be assisted to capture based on the target reference image currently displayed through different types of capture assistance information, so that capture assistance manners when capturing based on the reference image can be further enriched, and the capture difficulty when capturing based on the reference image can be reduced.

In some embodiments, the capturing guidance information may be displayed only for the second capturing parameter whose current parameter value does not match the target parameter value or the preset parameter value of the target reference image, so as to further improve the practicability of the displayed capturing guidance information. In this case, optionally, displaying the capturing guidance information corresponding to the second capturing parameter of the capture interface includes at least one of the following: displaying capturing mode guidance information in response to the current capturing mode of the capture interface being different from a target capturing mode of the target reference image, where the capturing mode guidance information is configured to guide to switch the current capturing mode to the target capturing mode; displaying capturing object guidance information in response to an absence of a first capturing object corresponding to the target reference image within the current capturing range corresponding to the capture interface, displaying capturing object guidance information, where the capturing object guidance information is configured to guide a capturing object adjustment and/or a capturing range adjustment; displaying imaging guidance information in response to current imaging information of the first capturing object in the capture interface failing to match target imaging information of a second capturing object in the target reference image, where the imaging guidance information is configured to guide an adjustment of the current imaging information; and displaying angle guidance information in response to a difference between a current capturing angle of the capture interface and a target capturing angle being greater than a preset angle threshold, where configured to guide an adjustment of the current capturing angle.

By way of example, in the case that the current capturing mode of the capture interface is different from the target capturing mode of the target reference image, for example, if the current capturing mode of the capture interface is the portrait capturing mode while the target capturing mode of the target reference image is the landscape capturing mode, or the current capturing mode of the capture interface is the landscape capturing mode while the target capturing mode of the target reference image is the portrait capturing mode, the capturing mode guidance information may be displayed in the capture interface, as shown in FIG. 5 (in the figure, the current capturing mode of the capture interface is the portrait capturing mode, and the target capturing mode of the target reference image is the landscape capturing mode as an example), and the user is guided to adjust the current capturing mode of the capture interface through the capturing mode guidance information.

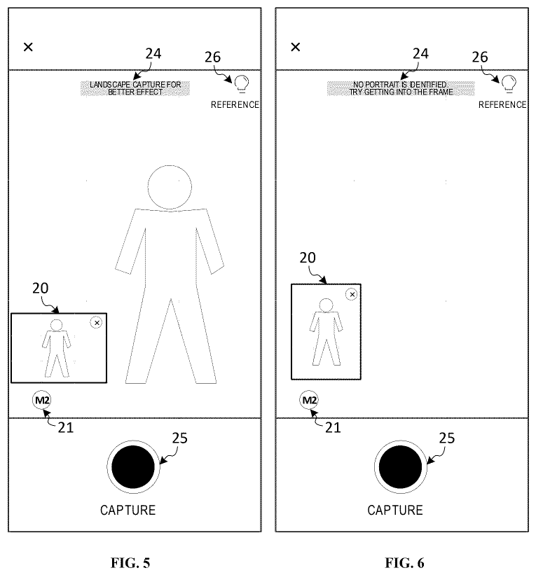

In the case that there is no first capturing object corresponding to the target reference image within the current capturing range of the capture interface, for example, when the target reference image is a single-person image and there is no person within the current capturing range of the capture interface, the capturing object guidance information may be displayed, as shown in FIG. 6, and the current user is guided by the capturing object guidance information to perform the capturing object adjustment and/or the capturing range adjustment, such as guiding the current user to adjust a position of the capturing object to make it within the current capturing range of the capture interface, and/or guiding the current user to adjust the current capturing range of the capture interface to enable a person to be within the current capturing range.

In the case that the current imaging information of the first capturing object in the capture interface does not match the target imaging information of the second capturing object in the target reference image 20, for example, when a ratio of a current imaging size of the first capturing object in the capture interface to a target imaging size of the second capturing object in the target reference image 20 is not within a preset ratio range, or when a distance between a current imaging position of the first capturing object in the capture interface and a target imaging position of the second capturing object in the target reference image 20 is greater than a preset distance threshold, the imaging guidance information may be displayed, as shown in the first guidance element 22, the second guidance element 23, the text guidance information 24, and the like in FIG. 3, and the current user is guided by the imaging guidance information to adjust the current imaging information of the first capturing object. Both the preset ratio range and the preset distance threshold may be set as needed. For example, the preset ratio range may be set to [0.8, 1.2] or [0.85, 1.15], etc., and the preset distance threshold may be set to 20 pixels, 30 pixels, or 40 pixels, etc.

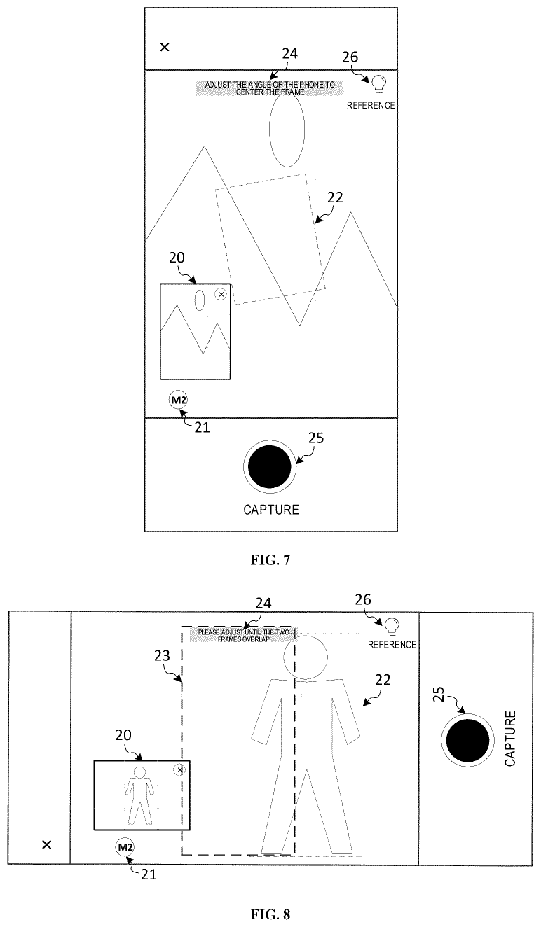

In the case that the current capturing angle of the capture interface does not match the target capturing angle, for example, in the case that the difference between the current capturing angle of the capture interface and the target capturing angle is greater than the preset angle threshold, the angle guidance information may be displayed, as shown in the first guidance element 22 and the text guidance information 24 in FIG. 7, and the current user is guided by the angle guidance information to adjust the current capturing angle of the capture interface to the target capturing angle.

The target capturing angle may be understood as a capturing angle to be adjusted to, that is, an expected capturing angle. The manner of determining the target capturing angle is not limited. For example, the target capturing angle may be obtained by setting in advance or determined based on a capturing angle of the target reference image. In this case, optionally, the target capturing angle is a preset capturing angle, or the target capturing angle corresponds to the target reference image. The preset angle threshold may be set as needed. For example, the preset angle threshold may be set to 20°, 30°, or 40°, etc.

In this embodiment, the capturing mode guidance information, the framing guidance information, the imaging guidance information, and the angle guidance information may be displayed simultaneously; or the capturing mode guidance information, the framing guidance information, the imaging guidance information, and the angle guidance information may be displayed according to a display priority set in advance, and the display priorities of the above guidance information are not limited. In some examples, the display priority of the capturing mode guidance information may be higher than the display priority of the framing guidance information, the display priority of the imaging guidance information, and the display priority of the angle guidance information, and the display priority of the framing guidance information may be higher than the display priority of the imaging guidance information, etc.

In some embodiments, when the capture interface rotates, for example, when the capture interface switches from the landscape capturing mode to the portrait capturing mode or from the portrait capturing mode to the landscape capturing mode (such as, rotating 90° or 270°, etc.), or when the capture interface flips (such as, rotating 180°), a display direction of at least part of interface content in the capture interface may be accordingly adjusted according to a rotation angle of the capture interface, as shown in FIG. 8, so that the at least part of interface content remains displayed in the forward direction for the current user before and after the adjustment, so as to facilitate the current user to view the at least part of interface content or perform reference capturing based on the at least part of interface content. In this case, optionally, the method for capturing image content may further include: in response to a change in the current capturing mode of the capture interface, adjusting a display direction of at least part of interface content in the capture interface based on the changed current capturing mode, where the at least part of interface content includes the target reference image and/or the capture assistance information. The at least part of interface content for maintaining the proper display may be set as needed. For example, the at least part of interface content may include but is not limited to the target reference image and/or the capture assistance information in the capture interface, and may further include at least part of controls displayed in the capture interface and/or the current parameter value of the first capturing parameter, etc.

In some embodiments, the information type of the capturing guidance information corresponding to the second capturing parameter of the capture interface is not limited. For example, the capturing guidance information may include a guidance element and/or text guidance information, so as to further enrich the display manner of the capturing guidance information, and improve the capturing guidance effect of the capturing guidance information. In this case, optionally, displaying the capturing guidance information corresponding to the second capturing parameter of the capture interface includes: displaying a guidance element corresponding to the second capturing parameter of the capture interface in a second region of the capture interface; and/or displaying text guidance information corresponding to the second capturing parameter of the capture interface in a third region of the capture interface.

The guidance element may be understood as a visual element configured for capturing guidance. An element type of the visual element is not limited. Optionally, the guidance element is displayed in a form of a preset graphic. For example, the guidance element may be displayed in a form of a square, such as a guidance frame or the like, which may be specifically set as needed. The text guidance information may be understood as text-based capturing guidance information, such as copywriting for capturing guidance.

Specifically, when displaying the capturing guidance information corresponding to the second capturing parameter of the capture interface, for example, the guidance element (the first guidance element 22 and/or the second guidance element 23 as shown in FIGS. 3, 7, and 8) and/or the text guidance information 24 (as shown in FIGS. 3 and 5-8) corresponding to the second capturing parameter of the capture interface may be displayed in the second region of the capture interface.

In some examples, when performing capturing mode guidance, for example, when displaying the capturing mode guidance information, the capturing mode guidance information may include the text guidance information 24, for example, the current user may be guided by the text guidance information 24 to switch the current capturing mode of the capture interface, as shown in FIG. 5; when performing capturing object guidance, for example, when displaying the capturing object guidance information, the capturing object guidance information may include the text guidance information 24, for example, the current user may be guided by the text guidance information 24 to perform the capturing object adjustment and/or the capturing range adjustment, as shown in FIG. 6; when performing imaging guidance, for example, when displaying the imaging guidance information, the imaging guidance information may include the text guidance information 24 and the guidance element (such as the first guidance element 22 and/or the second guidance element 23), as shown in FIGS. 3 and 8, so as to guide the current user to adjust the current imaging information of the capture interface through the text guidance information 24 and the guidance element together; and when performing angle guidance, for example, when displaying the angle guidance information, the angle guidance information may include the text guidance information 24 and the guidance element (such as the first guidance element 22), as shown in FIG. 7, so as to guide the current user to adjust the current capturing angle of the capture interface through the text guidance information 24 and the guidance element together.

In this embodiment, a number of the displayed guidance elements may be set as needed. Optionally, displaying, in the second region of the capture interface, the guidance element corresponding to the second capturing parameter of the capture interface includes: displaying a first guidance element in the second region of the capture interface; or displaying the first guidance element and a second guidance element in the second region of the capture interface; where the first guidance element indicates current imaging information of the first capturing object, and the second guidance element indicates target imaging information of a second capturing object in the target reference image; and/or the first guidance element indicates a current capturing angle of the first capturing object, and the second guidance element indicates a target capturing angle.

The first guidance element may be understood as a guidance element corresponding to the second capturing parameter of the capture interface. For example, the first guidance element may be configured to indicate current imaging information and/or a current capturing angle of the first capturing object in the capture interface. The second guidance element may be understood as a guidance element corresponding to the target reference image. For example, the second guidance element may be configured to indicate target imaging information of the second capturing object in the target reference image.

Specifically, when capturing guidance is performed by using the guidance element, the first guidance element and the second guidance element may be simultaneously displayed in the second region of the capture interface. The current parameter value of the second capturing parameter of the capture interface is indicated by using the first guidance element. For example, the current imaging information and/or the current capturing angle of the first capturing object in the capture interface are indicated by using the first guidance element. The expected parameter value of the second capturing parameter of the capture interface is indicated by using the second guidance element. For example, the target imaging information and/or the target capturing angle of the second capturing object in the target reference image are indicated by using the second guidance element. Alternatively, only the first guidance element may be displayed in the second region of the capture interface, and the current parameter value of the second capturing parameter of the capture interface is indicated by using the first guidance element. For example, the current imaging information and/or the current capturing angle of the first capturing object in the capture interface are indicated by using the first guidance element. In this case, the second guidance element is not displayed.

In some examples, when the imaging guidance information is displayed, the first guidance element 22 and the second guidance element 23 may be displayed simultaneously in the second region of the capture interface, the current imaging information of the first capturing object in the capture interface is indicated by the first guidance element 22, and the target imaging information of the second capturing object in the target reference image 20 is indicated by the second guidance element 23, as shown in FIGS. 3 and 8. When the angle guidance information is displayed, the first guidance element 22 may be displayed in the second region of the capture interface, the current capturing angle of the capture interface is indicated by the first guidance element 22, and the second guidance element 23 is not displayed in the second region of the capture interface, as shown in FIG. 7.

Additionally, in a case of imaging guidance and capturing a single-person portrait, a position of the second capturing object indicated by the second guidance element may be preset. For example, the second guidance element is preset to indicate an imaging position of the head, the upper body, or the whole body of the second capturing object. Alternatively, the position of the second capturing object indicated by the second guidance element may be determined based on an imaging part of the second capturing object in the target reference image. If an image of the second capturing object from the head to the feet can be identified in the target reference image, the second guidance element may be used for indicating the imaging position of the second capturing object from the head to the feet, for example, the second guidance element is generated based on the imaging position of the second capturing object from the head to the feet. If an image of the second capturing object from the head to the knees can be identified in the target reference image, but an image of the second capturing object below the knees cannot be identified, the second guidance element may be used for indicating an imaging position of the second capturing object from the head to the knees, for example, the second guidance element is generated based on the imaging position of the second capturing object from the head to the knees. If an image of the second capturing object from the head to the waist can be identified in the target reference image, but an image of a lower part of the body of the second capturing object cannot be identified, the second guidance element may be used for indicating an imaging position of the second capturing object from the head to the waist, for example, the second guidance element is generated based on the imaging position of the second capturing object from the head to the waist. If a head image of the second capturing object can be identified in the target reference image, but an image of the waist and the part below the waist of the second capturing object cannot be identified, the second guidance element may be used for indicating an imaging position of the head of the second capturing object, for example, the second guidance element is generated based on the imaging position of the head of the second capturing object. A position of the first capturing object indicated by the first guidance element may correspond to the position of the second capturing object currently indicated by the second guidance element.

The manner of determining the display style of the first guidance element and/or the second guidance element is not limited. Optionally, the display style of the first guidance element in the second region is associated with the current imaging information and/or the current capturing angle of the first capturing object, and the display style of the second guidance element in the second region is associated with the target imaging information and/or the target capturing angle of the second capturing object in the target reference image, the display style including at least one of a display size, a display position, and a display direction.

Specifically, the display style of the first guidance element may be determined based on the current imaging information and/or the current capturing angle of the first capturing object. For example, when imaging guidance is performed by using the first guidance element, the display size and/or the display position of the first guidance element may be determined based on the current imaging information of the first capturing object, so as to indicate the current imaging information of the first capturing object. When angle guidance is performed by using the first guidance element, the display direction of the first guidance element may be determined based on the current capturing angle of the first capturing object, so as to indicate the current capturing angle of the first capturing object. Additionally or alternatively, the display style of the second guidance element may be determined based on the target imaging information and/or the target capturing angle of the second capturing object. For example, when imaging guidance is performed by using the second guidance element, the display size and/or the display position of the second guidance element may be determined based on the target imaging information of the second capturing object, so as to indicate the target imaging information of the second capturing object. When angle guidance is performed by using the second guidance element, the display direction of the second guidance element may be determined based on the preset capturing angle and/or the target capturing angle of the second capturing object, so as to indicate the capturing angle to be adjusted to.

In some embodiments, the method for capturing image content may further include: adding, in response to the reference image display operation, a target parameter value corresponding to the target reference image as a candidate parameter value to a set of candidate parameter values of a first capturing parameter; and switching, in response to a parameter value switching operation for the first capturing parameter, a current parameter value of the first capturing parameter based on the set of candidate parameter values.

The candidate parameter value may be understood as a parameter value that may be switched to through the parameter value switching operation. The set of candidate parameter values may be a candidate parameter value set, and the set of candidate parameter values may include at least one candidate parameter value. The parameter value switching operation may be understood as an operation of switching the current parameter value based on the candidate parameter value in the set of candidate parameter values. The manner of performing the parameter value switching operation is not limited. By way of example, the parameter value switching operation may include an operation of triggering a parameter value switching control or an operation of triggering the current parameter value displayed in the capture interface.

Specifically, when the target reference image is displayed in the capture interface, the target parameter value (such as a zoom ratio value) of the target reference image may be added as a candidate parameter value of the first capturing parameter (such as the zoom ratio) of the capture interface to the set of candidate parameter values of the first capturing parameter; and when the parameter value switching operation for the first capturing parameter is received, for example, when it is detected that the current user clicks on the current parameter value 21 displayed in the capture interface, the current parameter value of the first capturing parameter may be switched based on the set of candidate parameter values of the first capturing parameter. For example, the current parameter value 21 is switched to a next candidate parameter value in the set of candidate parameter values.

For example, if the first capturing parameter is the zoom ratio, and a target zoom ratio value (that is, the target parameter value) of the target reference image is 1.3×, it is assumed that before the target zoom ratio value is added, a set of candidate zoom ratio values (that is, the candidate parameter value) of the zoom factor is {0.5×, 1×, 2×, 3×}, and after the target zoom ratio value is added, the set of candidate zoom ratio values of the zoom ratio becomes {0.5×, 1×, 1.3×, 2×, 3×}. Thus, during the target reference image is displayed, upon receiving the parameter value switching operation for the zoom ratio, the zoom ratio may be switched based on the set of candidate zoom ratio values after the target zoom ratio value is added.

In some examples, the current user may also be supported to adjust the zoom factor by multi-finger scaling. In this case, the zoom ratio value to be adjusted to of the first capturing parameter may be determined based on a sliding distance when the current user performs multi-finger scaling. After the target reference image is closed, the added target parameter value corresponding to the target reference image may be deleted from the set of candidate parameter values.

In this embodiment, in accordance with that the current parameter value 21 of the first capturing parameter is the target parameter value and the current parameter value 21 is not the target parameter value, the display style of the current parameter value 21 may be the same or different. Optionally, in accordance with that the current parameter value 21 is the target parameter value and the current parameter value 21 is not the target parameter value, the current parameter value 21 has a different display style in the capture interface, as shown in FIGS. 2 and 3, so as to facilitate the current user to quickly determine whether the current parameter value 21 is the target parameter value.

In this embodiment, when the parameter value switching operation is performed, the target parameter value is supported as a candidate parameter value to switch the current parameter value of the first capturing parameter, which may further enrich the switching manner of the parameter value of the first capturing parameter.

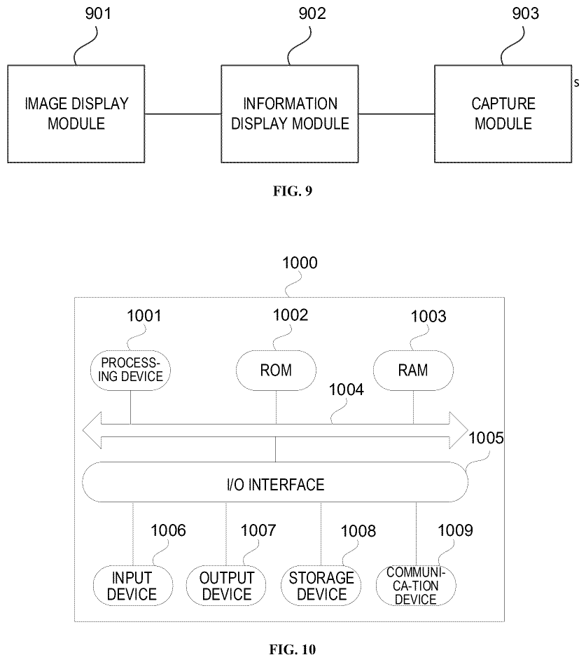

FIG. 9 is a structural block diagram of an apparatus for capturing image content provided by an embodiment of the present disclosure. The apparatus may be implemented by software and/or hardware, and may be configured in an electronic device. Typically, the apparatus may be configured in a computer, a mobile phone or a tablet computer. The apparatus may perform capturing of image content based on a reference image by executing the method of capturing image content, for example, by guiding capturing of the image content based on the reference image with capture assistance information. As shown in FIG. 9, the apparatus for capturing image content provided by this embodiment may include: an image display module 901, an information display module 902, and a capture module 903, where
the image display module 901 is configured to display, in response to a reference image display operation, a target reference image in a first region of a capture interface, the target reference image corresponding to the reference image display operation;
the information display module 902 is configured to display capture assistance information in the capture interface, where the capture assistance information is configured to assist capturing based on the target reference image, and at least part of the capture assistance information is determined based on the target reference image;
the capture module 903 is configured to capture target image content in response to a capture instruction.

According to the apparatus for capturing image content provided by the embodiments, the image display module displays, in response to the reference image display operation, the target reference image corresponding to the reference image display operation in the first region of the capture interface. The information display module displays the capture assistance information in the capture interface. The capture assistance information is configured to assist capturing based on the currently displayed target reference image, and at least part of the capture assistance information is determined based on the currently displayed target reference image. The capture module captures the target image content in response to the capture instruction. According to the embodiments, the above technical solution enables displaying of the capture assistance information determined based on the currently displayed reference image in the capture interface, and the user is assisted to capture based on the currently displayed reference image with the capture assistance information, which enriches the manners of capturing image content based on the reference image, reduces the capture difficulty when capturing based on the reference image, and improves the effect of capturing image content based on the reference image.

Further, the apparatus for capturing image content may further include at least one of the following: a first instruction acquiring module configured to acquire feedback information and/or acquiring the capture instruction in accordance with a determination that capturing parameter information of the capture interface matches the capture assistance information; and a second instruction acquiring module configured to acquire the capture instruction based on a capture operation.

Optionally, the first instruction acquiring module may be specifically configured to: acquire the feedback information and/or acquire the capture instruction in accordance with a determination that the capturing parameter information of the capture interface matches target parameter information of the target reference image.

Optionally, the target reference image is associated with target media content posted by a user of a current application, and the capture assistance information is determined based on the target media content posted by the user or associated information input by the user.

Optionally, the image display module 901 may be specifically configured to display a media content display interface; display the target media content in the media content display interface; displaying the capture interface based on a trigger for the media content display interface, and display the target reference image and/or the associated information of the target media content in the first region of the capture interface, the target reference image is determined based on the target media content; or the image display module 901 may be specifically configured to: display the capture interface; and display the target reference image and/or the associated information of the target media content in the first region of the capture interface in response to a trigger for the capture interface, the target reference image being determined based on the target media content.

Optionally, the information display module 902 may be specifically configured to acquire the capture assistance information determined based on the target media content posted by the user or the associated information input by the user, and display the capture assistance information at an associated position in the capture interface, the associated position being a preset position and/or being associated with a type of the capture assistance information.

Optionally, the capture assistance information being determined based on the target media content posted by the user or the associated information input by the user includes: the capture assistance information is determined by performing image detection based on the target media content posted by the user; and/or the capture assistance information is determined based on image information of the target media content edited by the user.

Optionally, the at least part of the capture assistance information being associated with the target reference image includes: the at least part of the capture assistance information is generated based on parameter information associated with the target reference image, the parameter information being determined based on image information associated with the target reference image and/or being obtained based on image detection.

Optionally, the parameter information includes at least one of a target parameter value, a target capturing mode, target imaging information, or a target capturing angle.

Optionally, the information display module 902 includes a reference line display unit, a parameter value adjustment unit, and a capturing guidance unit. The reference line display unit is configured to display reference lines in the first region and a second region of the capture interface, respectively, where the second region is configured to display a preview picture within a current capturing range. The parameter value adjustment unit is configured to adjust a current parameter value of a first capturing parameter of the capture interface to a target parameter value corresponding to the target reference image, and display the adjusted current parameter value in the capture interface. The capturing guidance unit is configured to display capturing guidance information corresponding to a second capturing parameter of the capture interface, where the capturing guidance information is configured to guide an adjustment to the second capturing parameter of the capture interface.

Optionally, the capture assistance information further includes at least one of the following: the reference lines include grid reference lines; the first capturing parameter includes a zoom ratio; the first capturing parameter includes an aperture parameter; the second capturing parameter includes at least one of a current capturing mode, current imaging information of a first capturing object, or a current capturing angle, where the current capturing mode includes a portrait capturing mode and/or a landscape capturing mode, the first capturing object is an object to be captured, and the imaging information includes an imaging size and/or an imaging position.

Optionally, the second capturing parameter guided by the capturing guidance information is enabled to be preset, or the second capturing parameter guided by the capturing guidance information is enabled to be determined based on an object type and/or an object number of a second capturing object in the target reference image.

Optionally, the capturing guidance unit may be specifically configured to perform at least one of the following: displaying capturing mode guidance information in response to the current capturing mode of the capture interface being different from a target capturing mode of the target reference image, the capturing mode guidance information being configured to guide to switch the current capturing mode to the target capturing mode; displaying capturing object guidance information in response to an absence of a first capturing object corresponding to the target reference image within the current capturing range corresponding to the capture interface, the capturing object guidance information being configured to guide a capturing object adjustment and/or a capturing range adjustment; displaying imaging guidance information in response to current imaging information of the first capturing object in the capture interface failing to match target imaging information of a second capturing object in the target reference image, the imaging guidance information being configured to guide an adjustment of the current imaging information; displaying angle guidance information in response to a difference between a current capturing angle of the capture interface and a target capturing angle being greater than a preset angle threshold, the angle guidance information being configured to guide an adjustment of the current capturing angle.

Optionally, the target capturing angle is a preset capturing angle, or the target capturing angle corresponds to the target reference image.

Optionally, the capturing guidance unit includes a first guidance subunit and/or a second guidance subunit. The first guidance subunit is configured to display, in a second region of the capture interface, a guidance element corresponding to the second capturing parameter of the capture interface. The second guidance subunit is configured to display, in a third region of the capture interface, text guidance information corresponding to the second capturing parameter of the capture interface.

Optionally, the first guidance subunit may be specifically configured to: display a first guidance element in the second region of the capture interface; or display the first guidance element and a second guidance element in the second region of the capture interface; where the first guidance element indicates current imaging information of the first capturing object, and the second guidance element indicates target imaging information of a second capturing object in the target reference image; and/or the first guidance element indicates a current capturing angle of the first capturing object, and the second guidance element indicates a target capturing angle.

Optionally, a display style of the first guidance element in the second region is associated with the current imaging information and/or the current capturing angle of the first capturing object, and a display style of the second guidance element in the second region is associated with the target imaging information and/or the target capturing angle of the second capturing object in the target reference image, and the display style includes at least one of a display size, a display position, or a display direction.

Optionally, the guidance element is displayed in a form of a preset graphic.

Optionally, the parameter value adjustment unit may be specifically configured to perform zooming processing on an original preview image within the current capturing range based on the target parameter value of the target reference image, and display a target preview image obtained by the zooming processing in the second region, where the zooming processing includes optical zooming processing and/or digital zooming processing.

Further, the apparatus for capturing image content may further include a display direction adjustment module configured to adjust, in response to a change in a current capturing mode of the capture interface, a display direction of at least part of interface content in the capture interface based on the changed current capturing mode, where the at least part of the interface content includes the target reference image and/or the capture assistance information.

Further, the apparatus for capturing image content may further include a parameter value adding module and a parameter value switching module. The parameter value adding module is configured to add, in response to the reference image display operation, a target parameter value corresponding to the target reference image as a candidate parameter value to a set of candidate parameter values of a first capturing parameter. The parameter value switching module is configured to switch, in response to a parameter value switching operation for the first capturing parameter, a current parameter value of the first capturing parameter based on the set of candidate parameter values.

Optionally, in accordance with that the current parameter value is the target parameter value and the current parameter value is not the target parameter value, the current parameter value has a different display style in the capture interface.

The apparatus for capturing image content provided by the embodiments of the present disclosure can execute the method for capturing image content provided by any of the embodiments of the present disclosure, and has corresponding functional modules and beneficial effects for executing the method for capturing image content. For the technical details not described in detail in the embodiments, reference may be made to the method for capturing image content provided by any of the embodiments of the present disclosure.

Reference is made to FIG. 10 below, which illustrates a schematic structural diagram of an electronic device (e.g., a terminal device) 1000 suitable for implementing the embodiments of the present disclosure. The terminal device in the embodiments of the present disclosure may include, but is not limited to, mobile terminals such as a mobile phone, a notebook computer, a digital broadcast receiver, a PDA (personal digital assistant), a PAD (tablet computer), a PMP (portable multimedia player), an in-vehicle terminal (e.g., an in-vehicle navigation terminal), etc., and fixed terminals such as a digital TV, a desktop computer, etc. The electronic device shown in FIG. 10 is only an example, and should not be construed as limiting the function and scope of use of the embodiments of the present disclosure.

As shown in FIG. 10, the electronic device 1000 may include a processing device (e.g., a central processing unit, a graphics processor, etc.) 1001, which may perform various appropriate actions and processing according to a program stored in a read-only memory (ROM) 1002 or a program loaded from a storage device 1008 into a random access memory (RAM) 1003. The RAM 1003 further stores various programs and data required for operations of the electronic device 1000. The processing device 1001, the ROM 1002, and the RAM 1003 are interconnected by means of a bus 1004. An input/output (I/O) interface 1005 is also connected to the bus 1004.

Usually, the following devices may be connected to the I/O interface 1005: an input device 1006 including, for example, a touch screen, a touchpad, a keyboard, a mouse, a camera, a microphone, an accelerometer, a gyroscope, etc.; an output device 1007 including, for example, a liquid crystal display (LCD), a speaker, a vibrator, etc.; a storage device 1008 including, for example, a magnetic tape, a hard disk, etc.; and a communication device 1009. The communication device 1009 may allow the electronic device 1000 to perform wireless or wired communication with other devices to exchange data. While FIG. 10 shows the electronic device 1000 having various devices, it should be understood that all of the illustrated devices are not necessarily implemented or provided. More or fewer devices may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for executing the method shown in the flowchart. In such an embodiment, the computer program may be downloaded and installed from a network through the communication device 1009, or installed from the storage device 1008, or installed from the ROM 1002. The computer program, when executed by the processing device 1001, performs the above functions defined in the method of the embodiments of the present disclosure.

It should be noted that the computer-readable medium in the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, apparatus, device, or any combination of the preceding. More specific examples of the computer-readable storage medium may include, but are not limited to an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the preceding. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried in the data signal. The data signal propagated in this manner may adopt multiple forms, including but not limited to an electromagnetic signal, an optical signal, or any suitable combination of the preceding. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to a wire, an optical cable, an RF (radio frequency), or any suitable combination of the preceding.

In some implementations, the client and the server may communicate using any currently known or future developed network protocol, such as the HTTP (HyperText Transfer Protocol), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, which, when executed by the electronic device, cause the electronic device to: display a target reference image in a first region of a capture interface in response to a reference image display operation, where the target reference image corresponds to the reference image display operation; display capture assistance information in the capture interface, where the capture assistance information is configured to assist capturing based on the target reference image, and at least part of the capture assistance information is determined based on the target reference image; and capture target image content in response to a capture instruction.

The computer program code for performing the operations of the present disclosure may be written in one or more programming languages or a combination thereof, where the programming languages include, but are not limited to, an object-oriented programming language such as Java, Smalltalk, C++, and also include conventional procedural programming languages such as “C” language or similar programming languages. The program code may be executed entirely on a user's computer, partly on the user's computer, as a stand-alone software package, partly on the user's computer and partly on a remote computer, or entirely on the remote computer or server. In the case of involving the remote computer, the remote computer may be connected to the user's computer through any kind of network, including a local area network (LAN) or a wide area network (WAN), or may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented in a software manner or a hardware manner. The name of the module does not constitute a limitation on the unit itself under certain circumstances.

The functions described above herein may be at least partially performed by one or more hardware logic components. For example, without limitation, example types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the preceding.

According to one or more embodiments of the present disclosure, Example 1 provides a method for capturing image content, including:
displaying, in response to a reference image display operation, a target reference image in a first region of a capture interface, the target reference image corresponding to the reference image display operation;
displaying capture assistance information in the capture interface, where the capture assistance information is configured to assist capturing based on the target reference image, and at least part of the capture assistance information is determined based on the target reference image;
capturing target image content in response to a capture instruction.

According to one or more embodiments of the present disclosure, Example 2 is according to the method of Example 1, and further includes at least one of the following:
acquiring feedback information and/or acquiring the capture instruction in accordance with a determination that capturing parameter information of the capture interface matches the capture assistance information;
acquiring the capture instruction in accordance with a determination that the capturing parameter information of the capture interface matches target parameter information of the target reference image;
acquiring the capture instruction based on a capture operation.

According to one or more embodiments of the present disclosure, Example 3 is according to the method of Example 2, where acquiring the feedback information and/or acquiring the capture instruction in accordance with a determination that the capturing parameter information of the capture interface matches the capture assistance information includes:
acquiring the feedback information and/or acquiring the capture instruction in accordance with a determination that the capturing parameter information of the capture interface matches target parameter information of the target reference image.

According to one or more embodiments of the present disclosure, Example 4 is according to the method of Example 1, where the target reference image is associated with target media content posted by a user of a current application, and the capture assistance information is determined based on the target media content posted by the user or associated information input by the user.

According to one or more embodiments of the present disclosure, Example 5 is according to the method of Example 4, where displaying, in response to the reference image display operation, the target reference image in the first region of the capture interface includes:
displaying a media content display interface;
displaying the target media content in the media content display interface;
displaying the capture interface based on a trigger for the media content display interface, and displaying the target reference image and/or the associated information of the target media content in the first region of the capture interface, the target reference image is determined based on the target media content; or
displaying, in response to the reference image display operation, the target reference image in the first region of the capture interface includes:
displaying the capture interface; and
displaying the target reference image and/or the associated information of the target media content in the first region of the capture interface in response to a trigger for the capture interface, the target reference image being determined based on the target media content.

According to one or more embodiments of the present disclosure, Example 6 is according to the method of Example 4, where displaying the capture assistance information in the capture interface includes:
acquiring the capture assistance information determined based on the target media content posted by the user or the associated information input by the user, and displaying the capture assistance information at an associated position in the capture interface, the associated position being a preset position and/or being associated with a type of the capture assistance information.

According to one or more embodiments of the present disclosure, Example 7 is according to the method of Example 4, where the capture assistance information being determined based on the target media content posted by the user or the associated information input by the user, includes:
the capture assistance information is determined by performing image detection based on the target media content posted by the user; and/or
the capture assistance information is determined based on image information of the target media content edited by the user.

According to one or more embodiments of the present disclosure, Example 8 is according to the method of Example 1, where the at least part of the capture assistance information being associated with the target reference image includes:
the at least part of the capture assistance information is generated based on parameter information associated with the target reference image, the parameter information being determined based on image information associated with the target reference image and/or being obtained based on image detection.

According to one or more embodiments of the present disclosure, Example 9 is according to the method of Example 8, where the parameter information includes at least one of a target parameter value, a target capturing mode, target imaging information, or a target capturing angle.

According to one or more embodiments of the present disclosure, Example 10 is according to the method of Example 1, where displaying the capture assistance information in the capture interface includes at least one of the following:
displaying reference lines in the first region and a second region of the capture interface, respectively, where the second region is configured to display a preview picture within a current capturing range;
adjusting a current parameter value of a first capturing parameter of the capture interface to a target parameter value corresponding to the target reference image, and displaying the adjusted current parameter value in the capture interface;
displaying capturing guidance information corresponding to a second capturing parameter of the capture interface, where the capturing guidance information is configured to guide an adjustment to the second capturing parameter of the capture interface.

According to one or more embodiments of the present disclosure, Example 12 is according to the method of Example 10, and further includes at least one of the following:
the reference lines include grid reference lines;
the first capturing parameter includes a zoom ratio;
the first capturing parameter includes an aperture parameter;
the second capturing parameter includes at least one of a current capturing mode, current imaging information of a first capturing object, or a current capturing angle, where the current capturing mode includes a portrait capturing mode and/or a landscape capturing mode, the first capturing object is an object to be captured, and the imaging information includes an imaging size and/or an imaging position.

According to one or more embodiments of the present disclosure, Example 12 is according to the method of Example 11, where the second capturing parameter guided by the capturing guidance information is enabled to be preset, or the second capturing parameter guided by the capturing guidance information is enabled to be determined based on an object type and/or an object number of a second capturing object in the target reference image.

According to one or more embodiments of the present disclosure, Example 13 is according to the method of Example 10, where displaying the capturing guidance information corresponding to the second capturing parameter of the capture interface includes at least one of the following:
displaying capturing mode guidance information in response to the current capturing mode of the capture interface being different from a target capturing mode of the target reference image, the capturing mode guidance information being configured to guide to switch the current capturing mode to the target capturing mode;
displaying capturing object guidance information in response to an absence of a first capturing object corresponding to the target reference image within the current capturing range corresponding to the capture interface, the capturing object guidance information being configured to guide a capturing object adjustment and/or a capturing range adjustment;
displaying imaging guidance information in response to current imaging information of the first capturing object in the capture interface failing to match target imaging information of a second capturing object in the target reference image, the imaging guidance information being configured to guide an adjustment of the current imaging information;
displaying angle guidance information in response to a difference between a current capturing angle of the capture interface and a target capturing angle being greater than a preset angle threshold, the angle guidance information being configured to guide an adjustment of the current capturing angle.

According to one or more embodiments of the present disclosure, Example 14 is according to the method of Example 13, where the target capturing angle is a preset capturing angle, or the target capturing angle corresponds to the target reference image.

According to one or more embodiments of the present disclosure, Example 15 is according to the method of Example 10, where displaying the capturing guidance information corresponding to the second capturing parameter of the capture interface includes:
displaying, in a second region of the capture interface, a guidance element corresponding to the second capturing parameter of the capture interface; and/or
displaying, in a third region of the capture interface, text guidance information corresponding to the second capturing parameter of the capture interface.

According to one or more embodiments of the present disclosure, Example 16 is according to the method of Example 15, where displaying, in the second region of the capture interface, the guidance element corresponding to the second capturing parameter of the capture interface includes:
displaying a first guidance element in the second region of the capture interface; or
displaying the first guidance element and a second guidance element in the second region of the capture interface;
where the first guidance element indicates current imaging information of the first capturing object, and the second guidance element indicates target imaging information of a second capturing object in the target reference image; and/or the first guidance element indicates a current capturing angle of the first capturing object, and the second guidance element indicates a target capturing angle.

According to one or more embodiments of the present disclosure, Example 17 is according to the method of Example 16, where a display style of the first guidance element in the second region is associated with the current imaging information and/or the current capturing angle of the first capturing object, and a display style of the second guidance element in the second region is associated with the target imaging information and/or the target capturing angle of the second capturing object in the target reference image, and the display style includes at least one of a display size, a display position, or a display direction.

According to one or more embodiments of the present disclosure, Example 18 is according to the method of Example 15, where the guidance element is displayed in a form of a preset graphic.

According to one or more embodiments of the present disclosure, Example 19 is according to the method of Example 10, where adjusting the current parameter value of the first capturing parameter of the capture interface to the target parameter value corresponding to the target reference image includes:
performing zooming processing on an original preview image within the current capturing range based on the target parameter value of the target reference image, and displaying a target preview image obtained by the zooming processing in the second region, where the zooming processing includes optical zooming processing and/or digital zooming processing.

According to one or more embodiments of the present disclosure, Example 20 is according to the method of any one of Examples 1-19, and further includes:
adjusting, in response to a change in a current capturing mode of the capture interface, a display direction of at least part of interface content in the capture interface based on the changed current capturing mode, where the at least part of the interface content includes the target reference image and/or the capture assistance information.

According to one or more embodiments of the present disclosure, Example 21 is according to the method of any one of Examples 1-19, and further includes:
adding, in response to the reference image display operation, a target parameter value corresponding to the target reference image as a candidate parameter value to a set of candidate parameter values of a first capturing parameter;
switching, in response to a parameter value switching operation for the first capturing parameter, a current parameter value of the first capturing parameter based on the set of candidate parameter values.

According to one or more embodiments of the present disclosure, Example 22 is according to the method of Example 21, where in accordance with that the current parameter value is the target parameter value and the current parameter value is not the target parameter value, the current parameter value has a different display style in the capture interface.

According to one or more embodiments of the present disclosure, Example 23 provides an apparatus for capturing image content, including:
an image display module configured to display, in response to a reference image display operation, a target reference image in a first region of a capture interface, the target reference image corresponding to the reference image display operation;
an information display module configured to display capture assistance information in the capture interface, where the capture assistance information is configured to assist capturing based on the target reference image, and at least part of the capture assistance information is determined based on the target reference image;
a capture module configured to capture target image content in response to a capture instruction.

According to one or more embodiments of the present disclosure, Example 24 provides an electronic device, including:
at least one processor; and
a memory communicatively connected to the at least one processor;
where the memory stores a computer program executable by the at least one processor, and the computer program is executed by the at least one processor to cause the at least one processor to perform the method for capturing image content of any one of Examples 1-22.

According to one or more embodiments of the present disclosure, Example 25 provides a non-transitory computer-readable storage medium having a computer program stored thereon, and the program, when executed by a processor, performs the method for capturing image content according to any one of Examples 1-22.

According to one or more embodiments of the present disclosure, Example 26 provides a computer program product which, when executed by a computer, causes the computer to implement the method for capturing image content according to any one of Examples 1-22.

The above description is merely an embodiment of the present disclosure and an illustration of the technical principles employed. Those skilled in the art should understand that the scope of disclosure involved in the present disclosure is not limited to the technical solutions formed by the specific combination of the above technical features, and should also cover, without departing from the concepts disclosed above, other technical solutions formed by any combination of the above technical features or their equivalent features. For example, a technical solution formed by replacing the above features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A method for image capturing, comprising:
displaying a reference image in a first region of an image capturing interface;
displaying assistance information in the image capturing interface, wherein the assistance information is configured to assist image capturing based on the reference image, and at least part of the assistance information is determined based on the reference image;
acquiring an image capturing instruction in response to that image capturing parameter information of the image capturing interface matches the assistance information; and
capturing an image in response to the image capturing instruction.

2. The method of claim 1, further comprising at least one of the following:
acquiring feedback information in response to that the image capturing parameter information of the image capturing interface matches the assistance information;
acquiring the image capturing instruction based on an image capturing operation.

3. The method of claim 2, wherein acquiring the feedback information in response to that the capturing parameter information of the image capturing interface matches the assistance information comprises:
acquiring the feedback information in response to that the capturing parameter information of the image capturing interface matches reference parameter information of the reference image.

4. The method of claim 1, wherein the reference image is associated with media content posted by a user, and the assistance information is determined based on the media content posted by the user or associated information input by the user.

5. The method of claim 4, wherein displaying the reference image in the first region of the image capturing interface comprises: displaying a media content display interface; displaying the media content in the media content display interface; displaying the image capturing interface based on a trigger for the media content display interface, and displaying the reference image and/or the associated information of the target media content in the first region of the image capturing interface, the reference image is determined based on the media content; or
wherein displaying the reference image in the first region of the image capturing interface comprises: displaying the image capturing interface; and displaying the reference image and/or the associated information of the media content in the first region of the image capturing interface in response to a trigger for the image capturing interface, the reference image being determined based on the media content.

6. The method of claim 4, wherein displaying the assistance information in the image capturing interface comprises:
acquiring the assistance information determined based on the media content posted by the user or the associated information input by the user, and displaying the assistance information at an associated position in the image capturing interface, the associated position being a preset position and/or being associated with a type of the assistance information.

7. The method of claim 4, wherein:
the assistance information is determined by performing image detection based on the media content posted by the user; and/or
the assistance information is determined based on image information of the media content edited by the user.

8. The method of claim 1, wherein the at least part of the assistance information is generated based on parameter information associated with the reference image, the parameter information being determined based on image information associated with the reference image and/or being obtained based on image detection, and
wherein the parameter information comprises at least one of a target parameter value, a target capturing mode, target imaging information, or a target capturing angle.

9. The method of claim 1, wherein displaying the assistance information in the image capturing interface comprises at least one of the following:
displaying capturing reference lines in the first region and a second region of the image capturing interface, respectively, wherein the second region is configured to display a preview picture within a current capturing range;
adjusting a current parameter value of a first capturing parameter of the image capturing interface to a target parameter value corresponding to the reference image, and displaying the adjusted current parameter value in the image capturing interface;
displaying capturing guidance information corresponding to a second capturing parameter of the image capturing interface, wherein the capturing guidance information is configured to guide an adjustment to the second capturing parameter of the image capturing interface.

10. The method of claim 9, further comprising at least one of the following:
the capturing reference lines comprise grid reference lines;
the first capturing parameter comprises a zoom ratio;
the first capturing parameter comprises an aperture parameter;
the second capturing parameter comprises at least one of a current capturing mode, current imaging information of a first capturing object, or a current capturing angle, wherein the current capturing mode comprises a portrait capturing mode and/or a landscape capturing mode, the first capturing object is an object to be captured, and the imaging information comprises an imaging size and/or an imaging position.

11. The method of claim 10, wherein the second capturing parameter guided by the capturing guidance information is enabled to be preset, or the second capturing parameter guided by the capturing guidance information is enabled to be determined based on an object type and/or an object number of a second capturing object in the reference image.

12. The method of claim 9, wherein displaying the capturing guidance information corresponding to the second capturing parameter of the image capturing interface comprises at least one of the following:
displaying capturing mode guidance information in response to the current capturing mode of the image capturing interface being different from a target capturing mode of the reference image, the capturing mode guidance information being configured to guide to switch the current capturing mode to the target capturing mode;
displaying capturing object guidance information in response to an absence of a first capturing object corresponding to the reference image within the current capturing range corresponding to the image capturing interface, the capturing object guidance information being configured to guide a capturing object adjustment and/or a capturing range adjustment;
displaying imaging guidance information in response to current imaging information of the first capturing object in the image capturing interface failing to match target imaging information of a second capturing object in the reference image, the imaging guidance information being configured to guide an adjustment of the current imaging information;
displaying angle guidance information in response to a difference between a current capturing angle of the image capturing interface and a target capturing angle being greater than a preset angle threshold, the angle guidance information being configured to guide an adjustment of the current capturing angle.

13. The method of claim 9, wherein displaying the capturing guidance information corresponding to the second capturing parameter of the image capturing interface comprises:
displaying, in a second region of the image capturing interface, a guidance element corresponding to the second capturing parameter of the image capturing interface; and/or
displaying, in a third region of the image capturing interface, character guidance information corresponding to the second capturing parameter of the image capturing interface.

14. The method of claim 13, wherein displaying, in the second region of the image capturing interface, the guidance element corresponding to the second capturing parameter of the image capturing interface comprises:
displaying a first guidance element in the second region of the image capturing interface; or
displaying the first guidance element and a second guidance element in the second region of the image capturing interface;
wherein the first guidance element indicates current imaging information of the first capturing object, and the second guidance element indicates target imaging information of a second capturing object in the reference image; and/or the first guidance element indicates a current capturing angle of the first capturing object, and the second guidance element indicates a target capturing angle.

15. The method of claim 14, wherein a display style of the first guidance element in the second region is associated with the current imaging information and/or the current capturing angle of the first capturing object, and a display style of the second guidance element in the second region is associated with the target imaging information and/or the target capturing angle of the second capturing object in the reference image, and the display style comprises at least one of a display size, a display position, or a display direction.

16. The method of claim 1, further comprising:
adjusting, in response to a change in a current capturing mode of the image capturing interface, a display direction of at least part of interface content in the image capturing interface based on the changed current capturing mode, wherein the at least part of the interface content comprises the reference image and/or the assistance information.

17. The method of claim 1, further comprising:
adding, in response to the reference image display operation, a target parameter value corresponding to the reference image as a candidate parameter value to a set of candidate parameter values of a first capturing parameter; and
switching, in response to a parameter value switching operation for the first capturing parameter, a current parameter value of the first capturing parameter based on the set of candidate parameter values.

18. The method of claim 17, wherein in accordance with that the current parameter value is the target parameter value and the current parameter value is not the target parameter value, the current parameter value has a different display style in the image capturing interface.

19. An electronic device, comprising:
at least one processor; and
a memory communicatively connected to the at least one processor;
wherein the memory stores a computer program executable by the at least one processor, and the computer program is executed by the at least one processor to cause the at least one processor to perform acts comprising:
displaying a reference image in a first region of a capturing interface;
displaying assistance information in the image capturing interface, wherein the assistance information is configured to assist capturing based on the reference image, and at least part of the assistance information is determined based on the reference image;
acquiring an image capturing instruction in response to that image capturing parameter information of the image capturing interface matches the assistance information; and
capturing an image in response to the image capturing instruction

20. A non-transitory computer-readable storage medium having computer instructions stored thereon, wherein the computer instructions, when executed by a processor, cause the processor to perform acts comprising:
displaying a reference image in a first region of a capturing interface;
displaying assistance information in the image capturing interface, wherein the assistance information is configured to assist capturing based on the reference image, and at least part of the assistance information is determined based on the reference image;
acquiring an image capturing instruction in response to that image capturing parameter information of the image capturing interface matches the assistance information; and
capturing an image in response to the image capturing instruction.
